(19) United States
(12) Patent Application Publication
(10) Pub. No.: US 2011/0085836 A1
(43) Pub. Date: Apr. 14, 2011

(54) Image forming apparatus forming copy prevention pattern and image processing method thereof

(75) Inventor: Ho-keun Lee, Suwon-si (KR)

(73) Assignee: Samsung Electronics Co., Ltd., Suwon-si (KR)

(21) Appl. No.: 12/659,811

(22) Filed: Mar. 22, 2010

(30) Foreign Application Priority Data
Oct. 13, 2009 (KR) 2009-0097393

(51) Int. Cl. G03G 21/00

(52) U.S. Cl. 399/366

(57) ABSTRACT

An image forming apparatus is provided which includes an input unit to receive an input image; an area determination unit to divide the input image into a plurality of areas, to compute a weight for at least one of a position, a density and a color of each of the plurality of divided areas and to determine an area on which a copy prevention pattern is to be superimposed among the plurality of divided areas; a generation unit to superimpose the copy prevention pattern on the determined area of the input image and to generate a copy prevention image; and an output unit to output the generated copy prevention image. Therefore, it is possible to select a position of a document into which the copy prevention pattern is to be inserted.

### CROSS-REFERENCE TO RELATED APPLICATIONS

This application claims the benefit of Korean Patent Application No. 10-2009-0097393, filed Oct. 13, 2009, in the Korean Intellectual Property Office, the disclosure of which is incorporated herein by reference.

### BACKGROUND

1. Field

Aspects of the present embodiments relate to an image forming apparatus and an image processing method thereof. More particularly, aspects of the present embodiments relate to an image forming apparatus to form a copy prevention pattern on a portion of a document, and an image processing method of the image forming apparatus.

2. Description of the Related Art

Image forming apparatuses function to generate, print, receive and transmit image data, and may include, for example, printers, scanners, copiers, fax machines, and multifunctional peripherals (MFP) combining operations of one or more of those devices.

Image forming apparatuses, such as copiers, aim to output documents or images of a plurality of copies without any change and to perform copying. Recently, a large number of companies are interested in a security function for documents generated by image forming apparatuses, and are requiring a copy restriction function for these documents.

Various studies are being made on functions of image forming apparatuses to allow only a specific person to copy and print a predetermined document or to allow only a specific method to be used to perform copying and printing. In more detail, functions of inserting a predetermined pattern into a document to restrict copying of the document by interpretation of the predetermined pattern are applied to image forming apparatuses.

Conventionally, copying of a security document generated by the above method is restricted only by an apparatus capable of recognizing the predetermined pattern, and thus there is a problem that an apparatus incapable of recognizing the pattern may copy the document. Additionally, there is another problem that if a predetermined pattern is inserted into an edge of a document, users could easily remove the pattern and copy the document.

### SUMMARY

Aspects of the present embodiments provide an image forming apparatus to select a position of a document into which a copy prevention pattern is to be inserted, and an image processing method of the image forming apparatus.

Additionally, aspects of the present embodiments provide a function of inserting a copy prevention pattern into a position desired by a user.

Furthermore, aspects of the present embodiments enable different kinds of apparatus to support a copy prevention function even when it is impossible to recognize a copy prevention pattern.

Additional aspects and/or advantages will be set forth in part in the description which follows and, in part, will be apparent from the description, or may be learned by practice of the invention.

The foregoing and/or other aspects are achieved by providing an image forming apparatus, including: an input unit to receive an input image; an area determination unit to divide the input image into a plurality of areas computing a weight for at least one characteristic of each of the plurality of divided areas and to determine an area on which a copy prevention pattern is to be superimposed among the plurality of divided areas based on the computed weight when the user command is not received; a generation unit to superimpose the copy prevention pattern on the determined area of the input image and to generate a copy prevention image; and an output unit to output the generated copy prevention image.

The area determination unit may add at least two of the weight for position, the weight for density and the weight for color, may compute a cost function for each of the plurality of divided areas, and may determine an area in which the computed cost function reaches its maximum value among the plurality of divided areas so that the copy prevention pattern is superimposed on the determined area in which the computed cost function reaches its maximum value.

The at least one characteristic of each of the divided areas may be one of a position, a density and a color.

The area determination unit may use any one of the weight for position, the weight for density and the weight for color or a combination thereof to compute a cost function for each of the plurality of divided areas, and may determine an area in which the computed cost function reaches a relatively higher value in relation to the other divided areas among the plurality of divided areas so that the copy prevention pattern is superimposed on the determined area in which the computed cost function reaches the relatively higher value

The weight for position may reach the relatively higher value in a central area of the input image, and the weight for position may decrease in relation to the distance away from the central area of the input image

The weight for density may be limited to the relatively higher value in a predetermined area of the input image so that the copy prevention image is identifiable by the image forming apparatus, a density of the predetermined area being proportional to the weight for density.

The weight for color may reach the relatively higher value in an area with a cyan pixel, an area with a magenta pixel, an area with a black pixel, an area with white and cyan pixels, an area with white and magenta pixels and an area with white and black pixels.

The copy prevention pattern may be a predefined pattern for recognition of money.

The color of the copy prevention pattern may be yellow.

The image forming apparatus may further include a user interface (UI) to receive a user command to determine the area on which the copy prevention pattern is to be superimposed.

The area determination unit may automatically or manually select the area on which the copy prevention pattern is to be superimposed, to determine where the copy prevention pattern is to be superimposed on the input image.

The relatively higher value may be a maximum value among the values in the divided areas.

The foregoing and/or other aspects are achieved by providing an image processing method of an image forming apparatus, the method including: receiving an input image; dividing the input image into a plurality of areas, computing a weight for at least one characteristic of each of the plurality of divided areas when a user command to determine an area on which a copy prevention pattern is to be superimposed is not received and determining an area on which a copy prevention pattern is to be superimposed among the plurality of divided areas, at an area determination unit, based on the computed weight; superimposing the copy prevention pattern on the determined area of the input image and generating a copy prevention image; and outputting the generated copy prevention image.

The at least one characteristic of each of the divided areas may be one of a position, a density and a color.

The determining the area on which the copy prevention pattern is to be superimposed may include determining whether a user command is received to select the area on which the copy prevention pattern is to be superimposed.

The determining the area on which the copy prevention pattern is to be superimposed may further include determining the area on which the copy prevention pattern is to be superimposed among the plurality of divided areas in response to the user command when it is determined that the user command is received.

The determining the area on which the copy prevention pattern is to be superimposed may include using any one of the weight for position, the weight for density and the weight for color, computing a cost function for each of the plurality of divided areas, and may include determine an area in which the computed cost function reaches a relatively higher value in relation to the other divided areas among the plurality of divided areas so that the copy prevention pattern is superimposed on the determined area in which the computed cost function reaches the relatively higher value.

The weight for position may reach the relatively higher value in a central area of the input image, and the weight for position may decrease in relation to the distance from the central area of the input image.

The weight for density may be limited to the relatively higher value in a predetermined area of the input image so that the copy prevention image is identifiable by the image forming apparatus, a density of the predetermined area being proportional to the weight for density.

The weight for color may reach the relatively higher value in an area with a cyan pixel, an area with a magenta pixel, an area with a black pixel, an area with white and cyan pixels, an area with white and magenta pixels and an area with white and black pixels.

The copy prevention pattern may be a predefined pattern for recognition of money.

The color of the copy prevention pattern may be yellow.

The determining the area on which the copy prevention pattern is to be superimposed may further include automatically or manually selecting the area on which the copy prevention pattern is to be superimposed.

The relatively higher value may be a maximum value among the values in the divided areas.

The foregoing and/or other aspects are achieved by providing an image forming apparatus, including: an input unit to receive an input image; an area determination unit to divide the input image into a plurality of areas, to compute a weight for at least one of a position, a density and a color of each of the plurality of divided areas and determining an area on which the money notes copy prevention pattern is to be superimposed among the plurality of divided areas based on the computed weight; a generation unit to superimpose the money notes copy prevention pattern on the determined area of the input image and to generate a copy prevention image; and an output unit to output the generated copy prevention image.

The area determination unit may use any one of the weight for position, the weight for density and the weight for color or a combination thereof, may compute a cost function for each of the plurality of divided areas, and may determine an area in which the computed cost function reaches a relatively higher value in relation to the other divided areas among the plurality of divided areas so that the money notes copy prevention pattern is superimposed on the determined area in which the computed cost function reaches the relatively higher value.

The weight for position may reach the relatively higher value in a central area of the input image, and the weight for position may decrease in relation to the distance from the central area of the input image.

The weight for density may be limited to the relatively higher value in a predetermined area of the input image so that the money notes copy prevention pattern is identifiable by the image forming apparatus, a density of the predetermined area being proportional to the weight for density.

The weight for color may reach the relatively higher value in an area with a yellow pixel, an area with a yellowish green pixel, an area with a red pixel, an area with a black pixel, an area with white and yellow pixels, an area with white and yellowish green pixels, an area with white and red pixels and an area with white and black pixels.

The image forming apparatus may further include: a user interface (UI) to receive the user command to determine the area on which the money notes copy prevention pattern is to be superimposed.

The foregoing and/or other aspects are achieved by providing an image forming apparatus, including: an input unit to receive an input image; an area determination unit to determine an area of the input image on which a money notes copy prevention pattern is to be superimposed based on a user input by scrolling through portions of the input image; a generation unit to superimpose the money notes copy prevention pattern on the determined area of the input image and to generate a copy prevention image; and an output unit to output the generated copy prevention image.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an image forming apparatus according to at least one embodiment;

FIG. 2 is a view illustrating a copy prevention pattern according to at least one embodiment;

FIGS. 3 to 5B are views illustrating a process of determining an area on which a copy prevention pattern is to be superimposed;

FIG. 6 is a view illustrating a user interface (UI) to receive a user command;

FIG. 7 is a flowchart illustrating an image processing method of an image forming apparatus according to at least one embodiment; and

FIG. 8 is a flowchart illustrating in greater detail the image processing method of FIG. 7.

### DETAILED DESCRIPTION

Reference will now be made in detail to the present embodiments, examples of which are illustrated in the accompanying drawings, wherein like reference numerals refer to like elements throughout. The embodiments are described below in order to explain the aspects of the present invention by referring to the figures.

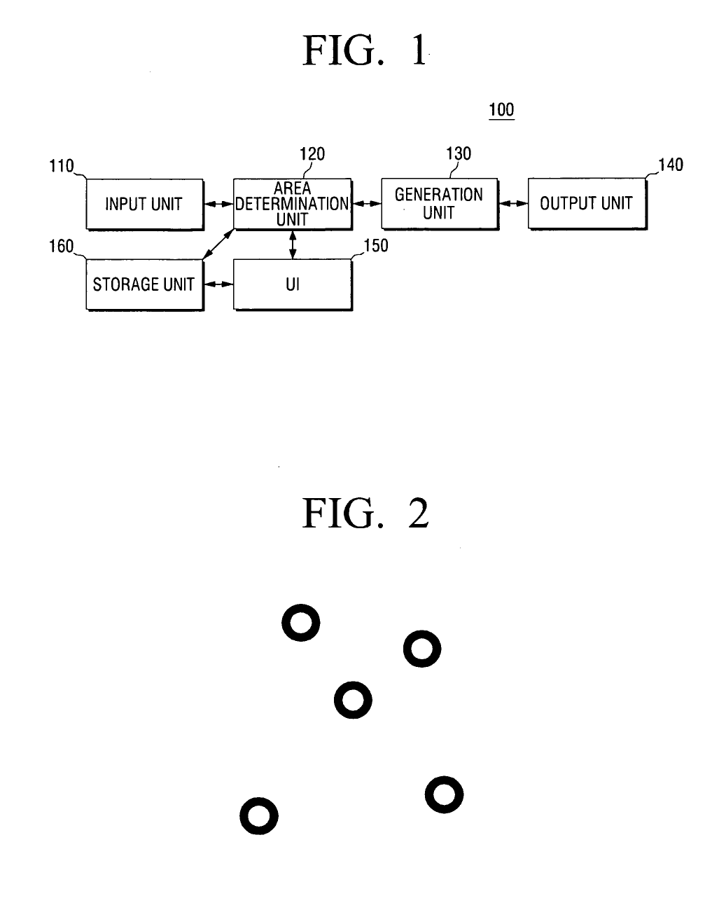

FIG. 1 is a block diagram of an image forming apparatus according to at least one embodiment. Referring to FIG. 1, the image forming apparatus 100 includes an input unit 110, an area determination unit 120, a generation unit 130, an output unit 140, a user interface (UI) 150 and a storage unit 160.

The input unit 110 receives an input image. In more detail, the input unit 110 may receive an RGB rendered image generated by a printer driver and an emulator, or an image scanned by an RGB sensor. Additionally, the input unit 110 may receive images through an automatic document feeder (ADF). An input image may contain content, such as serial letters or pictures.

In addition, the input unit 110 converts an 8-bit RGB image into CMYK, and may perform halftoning using an error diffusion method and a dithering method.

The area determination unit 120 determines the optimum area of the input image on which a copy prevention pattern is to be superimposed. In more detail, the area determination unit 120 may divide the input image into a plurality of areas, may compute a weight for at least one of parameters indicative of position, density and color of each of the plurality of areas, and may determine an area on which the copy prevention pattern is to be superimposed, among the plurality of areas. The plurality of areas may overlap with one another.

The area determination unit 120 may divide the input image into a plurality of areas in such a manner that each of the plurality of areas contains the entire copy prevention pattern. Alternatively, the area determination unit 120 may use information regarding a plurality of areas into which the input image is previously divided according to the size of print paper, such as A4 or B4.

The area determination unit 120 may automatically or manually select the area on which the copy prevention pattern is to be superimposed, through the UI 150, so as to determine where the copy prevention pattern is to be superimposed on the input image.

The area determination unit 120 may desirably compute weights with respect to the plurality of areas using all the parameters indicative of position, density and color.

The generation unit 130 may superimpose the copy prevention pattern on the area of the input image determined by the area determination unit 120, and may generate a copy prevention image. Herein, the superimposing operation involves inserting a yellow copy prevention pattern, for example, into the original input image with content. This inserting operation may be performed in a CMYK color space. Accordingly, the color of the copy prevention pattern on the copy prevention image generated by the generation unit 130 may be yellowish green or red in addition to yellow, that is, the original color of the copy prevention pattern. However, the color of the copy prevention pattern is not limited thereto.

The output unit 140 outputs the generated copy prevention image. The copy prevention image output from the output unit 140 is placed on a portion of a document, and may contain the copy prevention pattern with one of a yellow, yellowish green and red color, for example. Accordingly, the image forming apparatus 100 having a function of preventing money from being copied can recognize the copy prevention pattern.

The UI 150 receives a user command to determine the area on which the copy prevention pattern is to be superimposed. The UI 150 may enable a user to enter a command to manually or automatically select the area on which the copy prevention pattern is to be superimposed.

The storage unit 160 stores a variety of information required to perform the above-described operations. More specifically, the storage unit 160 may store information regarding the plurality of areas into which the input image is divided, information regarding the copy prevention pattern, information regarding the weight for position of each of the plurality of areas, information regarding the weight for density of each of the plurality of areas, and information regarding the weight for color of each of the plurality of areas.

Therefore, the copy prevention pattern may be inserted into a predetermined portion of the document in such a manner that it is difficult to identify the copy prevention pattern, and thus it is possible to prevent the document from being copied. Additionally, the copy prevention pattern according to the exemplary embodiment is based on a predefined pattern used to prevent counterfeiting of money notes, and accordingly, an input document may be recognized as money notes. Thus, the image forming apparatus 100 having the function of preventing money from being copied can prevent the input document from being copied, regardless of where the image forming apparatus 100 is manufactured.

An image forming apparatus 100 according to another exemplary embodiment may include an input unit 110 to receive an input image, an area determination unit 120 to divide the input image into a plurality of areas, to compute a weight for at least one parameter with respect to each of the plurality of areas and to determine an area on which a money notes copy prevention pattern is to be superimposed among the plurality of areas, a generation unit 130 to superimpose the money notes copy prevention pattern on the input image and to generate a copy prevention image, and an output unit 140 to output the generated copy prevention image. Herein, the money notes copy prevention pattern may be widely applied not only to the same kind of image forming apparatus, but also to different kinds of image forming apparatuses in order to prevent counterfeiting of money notes.

Image forming apparatuses of the same kind refer to serial products manufactured by the same manufacturer, and image forming apparatuses of different kinds refer to products manufactured by different manufacturers.

Accordingly, the image forming apparatus 100 according to this exemplary embodiment may use the money notes copy prevention pattern to prevent money from being copied regardless of where the image forming apparatus 100 is manufactured.

Hereinafter, overlapping description is omitted for convenience of description.

An image forming apparatus 100 according to another exemplary embodiment may include an input unit 110 to receive an input image, an area determination unit 120 to determine an area of the input image on which a money notes copy prevention pattern is to be superimposed through, for example, up, down, left and right scrolling, a generation unit 130 to superimpose the money notes copy prevention pattern on the input image and to generate a copy prevention image, and an output unit 140 to output the generated copy prevention image.

Accordingly, it is possible for a user to manually determine the area on which the money notes copy prevention pattern is to be superimposed, by scrolling up, down, left and right, for example.

An image forming system according to an exemplary embodiment includes an image forming apparatus and a host device. The image forming apparatus and the host device may be connected via wire or wirelessly.

The image forming apparatus receives an image through an input unit, such as a scanning module, and transmits the received image to the host device. After receiving the image from the image forming apparatus, the host device divides the received image into a plurality of areas, computes a weight for at least one parameter with respect to each of the plurality of areas, determines an area on which a copy prevention pattern is to be superimposed among the plurality of areas, superimposes the copy prevention pattern on the received image and generates a copy prevention image.

Subsequently, the host device may directly display the generated copy prevention image on a connected monitor. Alternatively, the host device may transmit the copy prevention image to an output unit of the image forming apparatus, and the output unit of the image forming apparatus may receive the copy prevention image from the host device and output the received copy prevention image.

FIG. 2 is a view illustrating a copy prevention pattern according to an exemplary embodiment. The copy prevention pattern may be inserted into money notes, such as the Korean won, the dollar or the yen, in order to prevent counterfeiting of money.

As shown in FIG. 2, the copy prevention pattern may be a special mark with five circles, for example, but is not limited to a mark with circles and may be any type of mark that provides the ability to distinguish between variations in the pattern. The copy prevention pattern may slightly vary for each country according to the distance between the circles and the arrangement of the circles. However, the image forming apparatus 100 may previously store copy prevention patterns for each country in the storage unit 160 in order to prevent money notes, such as Korean won, the dollar or the yen from being illegally copied.

Therefore, if a user desires to copy a document containing a copy prevention pattern, the image forming apparatus 100 may detect the copy prevention pattern from the document and recognize the document as a money note, and thus it is possible to prevent the document from being illegally copied.

The color of the copy prevention pattern may be one of yellow, yellowish green and red, for example, and may desirably be yellow. However, the color of the copy prevention pattern is not limited thereto and may be any of a variety of reproducible colors.

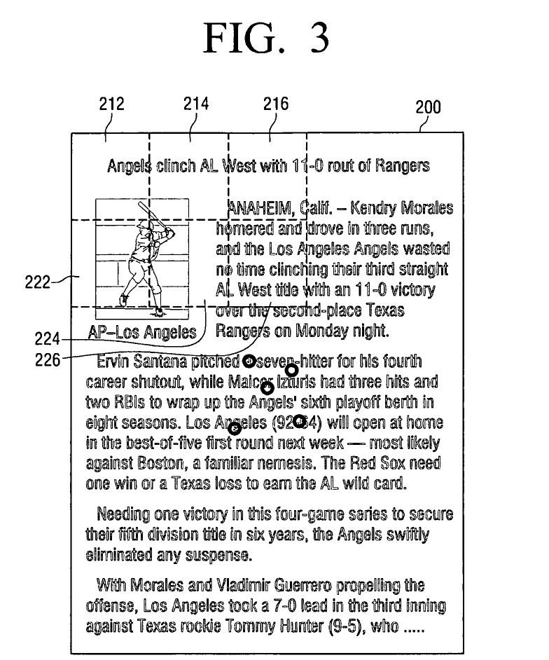

FIGS. 3 to 5B are views illustrating a process of determining the optimum area on which a copy prevention pattern is to be superimposed.

Referring to FIG. 3, an input image 200 containing content is divided into a plurality of areas. FIG. 3 merely illustrates areas 212, 214, 216, 222, 224 and 226, for convenience of description. Each of the plurality of areas includes a plurality of pixels.

The area 224 shown in FIG. 3 includes five pixels in a horizontal direction and five pixels in a vertical direction. However, this is merely an example, and actually a large number of pixels may be contained in a predetermined area of an image.

The area determination unit 120 may compute weights with respect to all of the plurality of areas in a predefined order, for example, in an order of areas 212, 214 and 216.

The area determination unit 120 may compute a weight for position, a weight for density and a weight for color with respect to each of the plurality of areas.

The weight for position may be computed using the following Equation 1:

$$Weight for position = \frac{1}{2} \sqrt{\begin{matrix}f ( x , \frac{1}{2} ( \begin{matrix}Width of \\ document\end{matrix} ) ) + \\ f ( y , \frac{1}{2} ( \begin{matrix}Height of \\ document\end{matrix} ) )\end{matrix}} \qquad [ Equation 1 ]$$

In Equation 1, x indicates the central horizontal position for each area, and y indicates the central vertical position for each area. Function f(x, a) is inversely proportional to a difference in value between x and a. When a copy prevention pattern is inserted into an edge of a document, a user may easily remove the copy prevention pattern and copy the document. To prevent the copy prevention pattern from being easily removed, the weight for position may reach its maximum value in the central area of the input image, and the farther away from the central area of the input image, the less the weight for position.

As shown in FIG. 3, for example, a weight for the area 226 neighboring the central area of the image may be greater than a weight for the edge area 212, which is further away from the central area of the image.

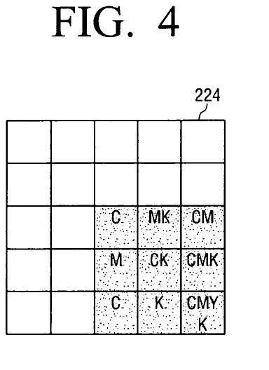

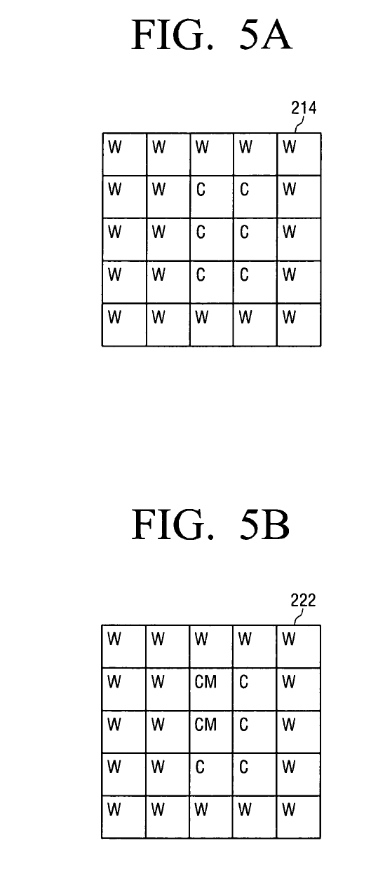

FIG. 4 is a view illustrating a process of computing the weight for density.

The weight for density may be computed using the following Equation 2:

$$\begin{matrix}Weight for \\ density\end{matrix} = \{ \begin{matrix}0 , & d \geq ( \begin{matrix}Maximum limit of density \times \\ Number of pixels in area\end{matrix} ) \\ \frac{d}{( \begin{matrix}Maximum limit of density \times \\ Number of pixels in area\end{matrix} )} , & d < ( \begin{matrix}Maximum limit of density \times \\ Number of pixels in area\end{matrix} )\end{matrix} \qquad [ Equation 2 ]$$

In Equation 2, d indicates the number of pixels of a predetermined area to which one color of cyan (C), magenta (M), yellow (Y) and black (K) is set.

If a density of the predetermined area exceeds the maximum limit of density, the image forming apparatus 100 may not recognize the copy prevention pattern even though the copy prevention pattern is superimposed on the image. Accordingly, in the present embodiments, the maximum limit of density of the predetermined area may be set to be less than 50%, but there is no limitation thereto.

Additionally, if the density of the predetermined area is reduced, it may be easy to identify the copy prevention pattern on the generated copy prevention image. In other words, if the density of the predetermined area is reduced, the weight for density may also be proportionally reduced.

Referring to FIG. 4, one or more colors of C, M, Y and K are set to nine pixels on a lower right side of the area 224 among 25 pixels of the area 224. Accordingly, a value of d in Equation 2 may be 9, and a weight for the area 224 may be 0.72 (9/12.5).

FIGS. 5A and 5B are views illustrating a process of computing the weight for color.

The weight for color may be computed using the following Equation 3:

$$Weight for color = \{ \begin{matrix}1 , & black and white \\ 1 , & cyan and white \\ 1 , & magenta and white \\ 0 , & else\end{matrix} \qquad [ Equation 3 ]$$

The color of the money notes copy prevention pattern described above may typically be yellow, yellowish green or red, for example. According to aspects of the present embodiments, the color of the copy prevention pattern may be yellow. However, the color of the copy prevention pattern is not limited thereto.

According to various exemplary embodiments, the yellow copy prevention pattern may be superimposed on an image with various colors. For example, if a yellow copy prevention pattern is combined with white of the image, a copy prevention image with the yellow copy prevention pattern may be generated. Additionally, if a yellow copy prevention pattern is combined with cyan of the image, a copy prevention image with a yellowish green copy prevention pattern may be generated. If a yellow copy prevention pattern is combined with magenta of the image, a copy prevention image with a red copy prevention pattern may be generated.

Furthermore, even when a predetermined area of an input image has a black pixel or white pixel, if a weight for density is less than 50%, the image forming apparatus may identify the yellow copy prevention pattern.

Accordingly, when a predetermined area of an input image has black or white pixels, or when the predetermined area has cyan or white pixels, or when the predetermined area has magenta or white pixels, the maximum weight for color may be set to 1. Thus, the weight for color reaches its maximum value in an area with a cyan pixel, an area with a magenta pixel, an area with a black pixel, an area with white and cyan pixels, an area with white and magenta pixels and an area with white and black pixels. In addition, the weight for color may reach its maximum value in an area with a yellow pixel, an area with a yellowish green pixel, an area with a red pixel, an area with a black pixel, an area with white and yellow pixels, an area with white and yellowish green pixels, an area with white and red pixels and an area with white and black pixels.

Referring to FIG. 5A, the area 214 has white and cyan pixels, so if a yellow copy prevention pattern is superimposed on the area 214, a copy prevention image with a yellowish green copy prevention pattern may be generated. A weight for color of the area 214 may be set to 1.

Referring to FIG. 5B, the area 222 has white, cyan and magenta pixels, so if a yellow copy prevention pattern is superimposed on the area 222, a bluish copy prevention pattern may appear, and it is thus impossible to identify the bluish copy prevention pattern. In other words, a weight for color of the area 222 may be set to 0.

When the weights with respect to each of the plurality of areas are computed as described above in FIGS. 3 to 5B, the area determination unit 120 may compute a cost function for each of the plurality of areas by adding the weight for position, the weight for density and the weight for color.

The cost function may be computed using the following Equation 4:

Cost function=a·Weight for position+b·Weight for density+c·Weight for color [Equation 4]

In Equation 4, a, b and c are real numbers equal to or greater than 0 or less than 1.

The area determination unit 120 finally determines an area in which the computed cost function reaches its maximum value, so that the copy prevention pattern is superimposed on the determined area.

The cost function may be computed using at least one of the weight for position, the weight for density and the weight for color, and may desirably be computed using all of the weight for position, the weight for density and the weight for color.

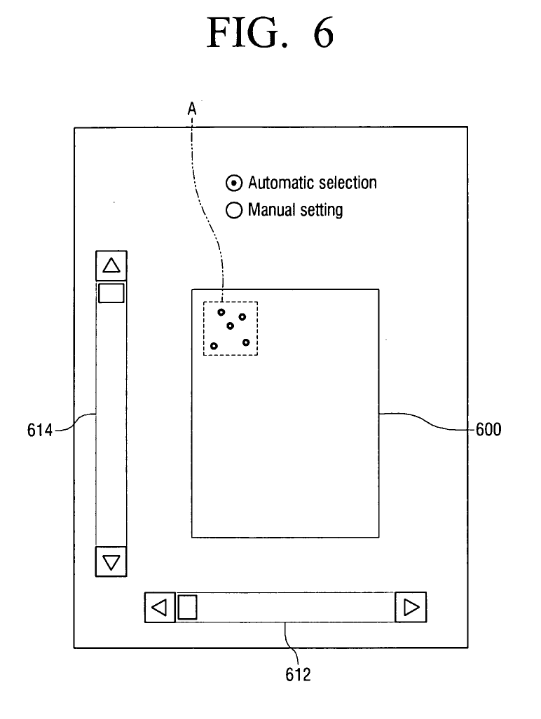

FIG. 6 is a view illustrating a user interface (UI) to receive a user command. Referring to FIG. 6, if a user selects an ‘automatic selection’ option through the UI, an area on which a copy prevention pattern is to be superimposed may be automatically determined using weights computed for each parameter and the cost function computed based on the weights.

Alternatively, if a user selects a ‘manual setting’ option through the UI, he or she may manually select area A of an input image 600 using a horizontal scroll bar 612 and a vertical scroll bar 614, for example, so that a copy prevention pattern may be superimposed on area A.

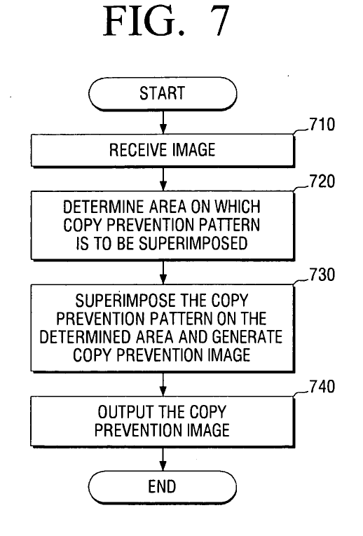

FIG. 7 is a flowchart illustrating an image processing method of an image forming apparatus according to at least one embodiment. Referring to FIG. 7, the input unit 110 receives an image in operation 710. The area determination unit 120 divides the input image into a plurality of areas, computes a weight for at least one of parameters indicative of position, density and color of each of the plurality of areas, and determines an area on which a copy prevention pattern is to be superimposed among the plurality of areas in operation 720.

Subsequently, the generation unit 130 superimposes the copy prevention pattern on the determined area of the input image, and generates a copy prevention image in operation 730. The output unit 140 outputs the generated copy prevention image in operation 740.

Operation 720 may further include automatically or manually selecting the area on which the copy prevention pattern is to be superimposed.

In the image processing method of the image forming apparatus according to the exemplary embodiment, the position of a document into which the copy prevention pattern is to be inserted may be selected using the weights and the cost function. Therefore, it is impossible to easily identify the copy prevention pattern, and thus it is possible to prevent the document from being copied. Additionally, the image forming apparatus may recognize a predetermined pattern in a content portion of the document, and therefore it is possible to increase user convenience.

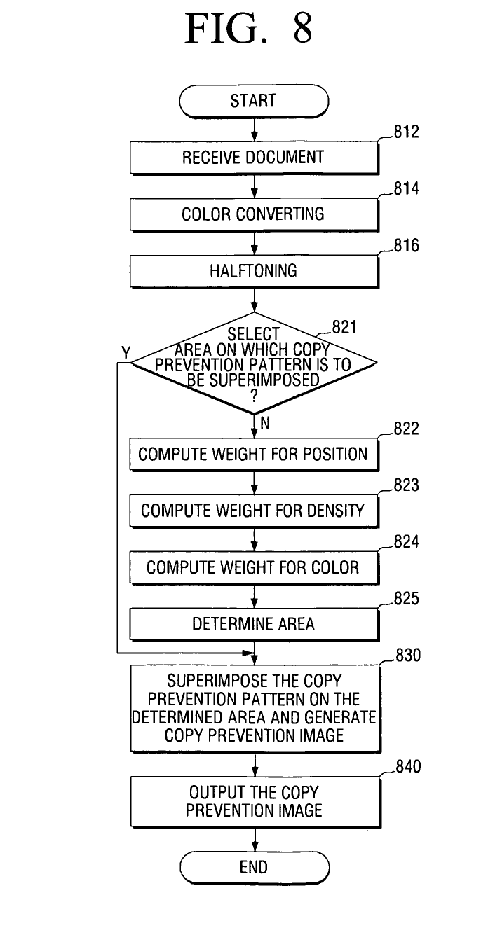

FIG. 8 is a flowchart illustrating in greater detail the image processing method of FIG. 7. Referring to FIG. 8, the image forming apparatus receives an image, namely, a document in operation 812, converts RGB data into CMYK data in operation 814, and then performs halftoning using an error diffusion method and a dithering method in operation 816.

Subsequently, it is determined whether a user enters a command at the UI 150 to select an area on which a copy prevention pattern is to be superimposed in operation 821.

If it is determined that the user enters the command in operation 821-Y, the image forming apparatus determines the area on which the copy prevention pattern is to be superimposed among the plurality of areas.

Alternatively, if it is determined that the user does not enter the command in operation 821-N, the area determination unit 120 computes the weight for position of each of the plurality of areas in operation 822, computes the weight for density of each of the plurality of areas in operation 823, and computes the weight for color of each of the plurality of areas in operation 824. Subsequently, the area determination unit 120 computes the cost function based on the computed weights, and determines an area in which the computed cost function reaches its maximum value so that the copy prevention pattern is superimposed on the determined area in operation 825.

The weight for position, the weight for density and the weight for color are sequentially computed as shown in FIG. 8. However, according to aspects of the present embodiments, the weight for position, the weight for density and the weight for color may be computed at the same time, or may be computed in sequences other than that shown in FIG. 8, or only a single weight may be computed.

After operation 825, the generation unit 130 superimposes the copy prevention pattern on the determined area of the input image, and generates a copy prevention image in operation 830. The output unit 140 outputs the generated copy prevention image in operation 840.

The area determination unit 120 may be a processing unit or cause a processor to execute the computations at the area determination unit 120.

Hereinafter, overlapping description is omitted for convenience of description.

The image processing method of the image forming apparatus according to aspects of the present embodiments may be implemented using a single processor or chip to perform each operation.

Aspects of the present embodiments can also be embodied as a computer-readable recording medium including a program to perform the method of providing UI content in the image forming apparatus and the method of receiving UI content in the host device according to the aspects of the present embodiments described above. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that a computer-readable code is stored and executed by a processor in a distributed fashion.

Although a few embodiments have been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
an input unit to receive an input image;
an area determination unit to divide the input image into a plurality of areas computing a weight for at least one characteristic of each of the plurality of divided areas and to determine an area on which a copy prevention pattern is to be superimposed among the plurality of divided areas based on the computed weight;
a generation unit to superimpose the copy prevention pattern on the determined area of the input image and to generate a copy prevention image; and
an output unit to output the generated copy prevention image.

2. The image forming apparatus according to claim 1, wherein the at least one characteristic of each of the divided areas is one of a position, a density and a color.

3. The image forming apparatus according to claim 2, wherein the area determination unit uses any one of the weight for position, the weight for density and the weight for color or a combination thereof to compute a cost function for each of the plurality of divided areas, and determines an area in which the computed cost function reaches a relatively higher value in relation to the other divided areas among the plurality of divided areas so that the copy prevention pattern is superimposed on the determined area in which the computed cost function reaches the relatively higher value.

4. The image forming apparatus according to claim 3, wherein the weight for position reaches the relatively higher value in a central area of the input image, and the weight for position decreases in relation to the distance away from the central area of the input image.

5. The image forming apparatus according to claim 3, wherein the weight for density is limited to the relatively higher value in a predetermined area of the input image so that the copy prevention image is identifiable by the image forming apparatus, a density of the predetermined area being proportional to the weight for density.

6. The image forming apparatus according to claim 3, wherein the weight for color reaches the relatively higher value in an area with a cyan pixel, an area with a magenta pixel, an area with a black pixel, an area with white and cyan pixels, an area with white and magenta pixels and an area with white and black pixels.

7. The image forming apparatus according to claim 1, wherein the copy prevention pattern is a predefined pattern for recognition of money.

8. The image forming apparatus according to claim 1, wherein the color of the copy prevention pattern is yellow.

9. The image forming apparatus according to claim 1, further comprising a user interface to receive the user command to determine the area on which the copy prevention pattern is to be superimposed.

10. The image forming apparatus according to claim 1, wherein the area determination unit automatically or manually selects the area on which the copy prevention pattern is to be superimposed, to determine where the copy prevention pattern is to be superimposed on the input image.

11. The image forming apparatus according to claim 3, wherein the relatively higher value is a maximum value among the values in the divided areas.

12. An image processing method of an image forming apparatus, the method comprising:
receiving an input image;
dividing the input image into a plurality of areas, computing a weight for at least one characteristic of each of the plurality of divided areas and determining an area on which a copy prevention pattern is to be superimposed among the plurality of divided areas, at an area determination unit, based on the computed weight;
superimposing the copy prevention pattern on the determined area of the input image and generating a copy prevention image; and
outputting the generated copy prevention image.

13. The method according to claim 12, wherein the at least one characteristic of each of the divided areas is one of a position, a density and a color.

14. The method according to claim 12, wherein the determining the area on which the copy prevention pattern is to be superimposed comprises determining whether a user command is received to select the area on which the copy prevention pattern is to be superimposed.

15. The method as claimed in claim 14, wherein the determining of the area on which the copy prevention pattern is to be superimposed further comprises, if it is determined that the user command is not received, computing at least one of a weight for position, a weight for density and a weight for color with respect to each of the plurality of areas.

16. The method according to claim 14, wherein the determining the area on which the copy prevention pattern is to be superimposed further comprises determining the area on which the copy prevention pattern is to be superimposed among the plurality of divided areas in response to the user command when it is determined that the user command is received.

17. The method according to claim 13, wherein the determining the area on which the copy prevention pattern is to be superimposed comprises using any one of the weight for position, the weight for density and the weight for color, computing a cost function for each of the plurality of divided areas, and determining an area in which the computed cost function reaches a relatively higher value in relation to the other divided areas among the plurality of divided areas so that the copy prevention pattern is superimposed on the determined area in which the computed cost function reaches the relatively higher value.

18. The method according to claim 17, wherein the weight for position reaches the relatively higher value in a central area of the input image, and the weight for position decreases in relation to the distance from the central area of the input image.

19. The method according to claim 17, wherein the weight for density is limited to the relatively higher value in a predetermined area of the input image so that the copy prevention image is identifiable by the image forming apparatus, a density of the predetermined area being proportional to the weight for density.

20. The method according to claim 17, wherein the weight for color reaches the relatively higher value in an area with a cyan pixel, an area with a magenta pixel, an area with a black pixel, an area with white and cyan pixels, an area with white and magenta pixels and an area with white and black pixels.

21. The method according to claim 12, wherein the copy prevention pattern is a predefined pattern for recognition of money.

22. The method according to claim 12, wherein the color of the copy prevention pattern is yellow.

23. The method according to claim 12, wherein the determining the area on which the copy prevention pattern is to be superimposed further comprises automatically or manually selecting the area on which the copy prevention pattern is to be superimposed.

24. The method according to claim 17, wherein the relatively higher value is a maximum value among the values in the divided areas.

25. An image forming apparatus, comprising:
an input unit to receive an input image;
an area determination unit to divide the input image into a plurality of areas, to compute a weight for at least one of a position, a density and a color of each of the plurality of divided areas when a user command to determine an area on which a money notes copy prevention pattern is to be superimposed is not received and determining an area on which the money notes copy prevention pattern is to be superimposed among the plurality of divided areas based on the computed weight when the user command is not received;
a generation unit to superimpose the money notes copy prevention pattern on the determined area of the input image and to generate a copy prevention image; and
an output unit to output the generated copy prevention image.

26. The image forming apparatus according to claim 24, wherein the area determination unit uses any one of the weight for position, the weight for density and the weight for color or a combination thereof, computes a cost function for each of the plurality of divided areas, and determines an area in which the computed cost function reaches a relatively higher value in relation to the other divided areas among the plurality of divided areas so that the money notes copy prevention pattern is superimposed on the determined area in which the computed cost function reaches the relatively higher value.

27. The image forming apparatus according to claim 26, wherein the weight for position reaches the relatively higher value in a central area of the input image, and the weight for position decreases in relation to the distance from the central area of the input image.

28. The image forming apparatus according to claim 26, wherein the weight for density is limited to the relatively higher value in a predetermined area of the input image so that the money notes copy prevention pattern is identifiable by the image forming apparatus, a density of the predetermined area being proportional to the weight for density.

29. The image forming apparatus according to claim 26, wherein the weight for color reaches the relatively higher value in an area with a yellow pixel, an area with a yellowish green pixel, an area with a red pixel, an area with a black pixel, an area with white and yellow pixels, an area with white and yellowish green pixels, an area with white and red pixels and an area with white and black pixels.

30. The image forming apparatus according to claim 25, further comprising: a user interface (UI) to receive the user command to determine the area on which the money notes copy prevention pattern is to be superimposed.

31. An image forming apparatus, comprising:
an input unit to receive an input image;
an area determination unit to determine an area of the input image on which a money notes copy prevention pattern is to be superimposed based on a user input by scrolling through portions of the input image;
a generation unit to superimpose the money notes copy prevention pattern on the determined area of the input image and to generate a copy prevention image; and
an output unit to output the generated copy prevention image.
